(19) United States
(12) Patent Application Publication
(10) Pub. No.: US 2025/0342060 A1
(43) Pub. Date: Nov. 6, 2025

(54) ADAPTIVE RESOURCE ALLOCATION

(71) Applicant: Dell Products L.P., Round Rock, TX (US)

(72) Inventors: Balakrishnan MV, Bangalore (IN); Kanika Ghai, San Jose, CA (US)

(21) Appl. No.: 18/653,556

(22) Filed: May 2, 2024

(51) Int. Cl. G06F 9/50

(52) U.S. Cl. CPC G06F 9/5038

(57) ABSTRACT

Methods, apparatus, and processor-readable storage media for adaptive resource allocation are provided herein. An example method includes obtaining usage data usage data relating to execution of a set of services and processing the usage data with a first machine learning model to determine one or more states corresponding to respective services in the set, where the first machine learning model evaluates one or more resource allocations for one or more services in the set based on the usage data. The method includes assigning a new resource allocation to at least one service in the set using a second machine learning model. The second machine learning model includes a prediction component that predicts the new resource allocation based on the determined one or more states corresponding to the at least one service, and a feedback component that updates the prediction component based on an evaluation of the new resource allocation.

### BACKGROUND

Edge computing generally refers to a distributed computing paradigm that positions data computation and/or data storage closer to the sources of data. Edge computing environments tend to be highly distributed and decentralized, and therefore present many challenges for information technology (IT) operations.

### SUMMARY

Illustrative embodiments of the disclosure provide techniques for adaptive resource allocation. An exemplary computer-implemented method includes obtaining usage data relating to execution of a set of services and processing the usage data with a first machine learning model to determine one or more states corresponding to one or more respective services of the set of services. The first machine learning model evaluates one or more resource allocations for one or more services in the set of services based on the usage data. The method also includes assigning a new resource allocation to at least one service in the set of services using a second machine learning model, where the second machine learning model includes a prediction component that predicts the new resource allocation based at least in part on the determined one or more states corresponding to the at least one service, and a feedback component that updates the prediction component based on an evaluation of the predicted new resource allocation.

Illustrative embodiments can provide significant advantages relative to conventional techniques. For example, some embodiments provide a machine learning framework that can automatically detect and improve resource allocations for one or more services (e.g., edge services). Additionally, one or more embodiments can adjust resource allocations to reduce latency based on respective priorities of applications and services.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for adaptive resource allocation in an illustrative embodiment.

FIG. 2 illustrates an adaptive resource allocation architecture in an illustrative embodiment.

FIG. 3 illustrates a classification machine learning model architecture in an illustrative embodiment.

FIG. 4 illustrates a neural network architecture for an actor network in accordance with an illustrative embodiment.

FIG. 5 illustrates a neural network architecture for a critic network in an illustrative embodiment.

FIG. 6 shows a flow diagram of a process for adaptive resource allocation in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Edge computing environments often provide a number of advantages in comparison to centralized data centers. Such advantages can include, for example, enhanced operational efficiency by reducing a distance between tasks and devices, such as Internet of Things (IoT) devices (e.g., sensors and robots), which subsequently leads to improved latency, response times, and/or decentralized workloads (including critical and non-critical workloads).

Although edge computing environments are becoming increasingly popular, several technical challenges remain. For example, edge computing environments have various constraints, including limited computing resources and limited scalability. Furthermore, unexpected spikes in workload occurrences due to heavy loads can result in overfitting or underfitting resources, which can lead to a shortage of resources for critical tasks.

One or more embodiments described herein can help address these and other challenges by providing adaptive resource allocation techniques that distribute resources according to usage patterns.

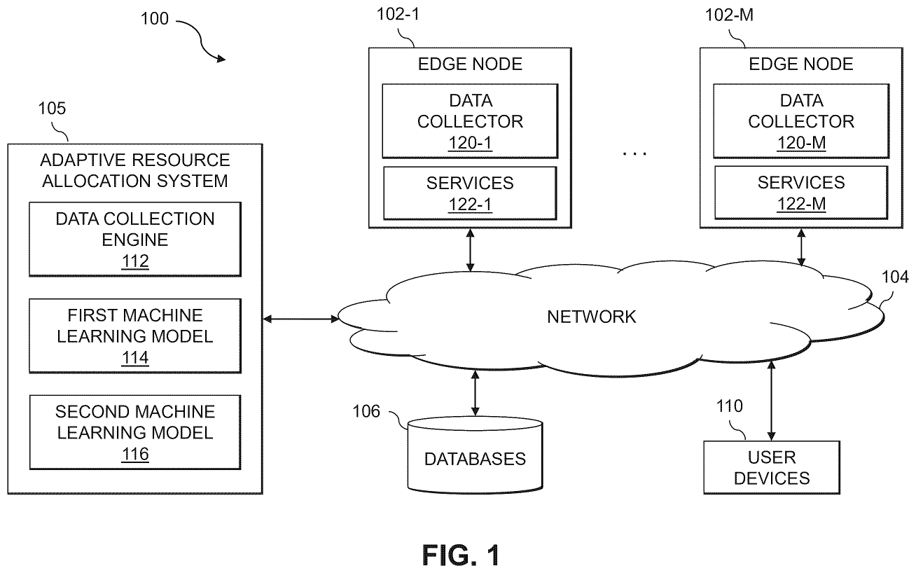

FIG. 1 shows a computer network (also referred to as a distributed computing system or an information processing system) 100 configured in accordance with an illustrative embodiment. The computer network 100 comprises a plurality of nodes, such as edge nodes 102-1, . . . 102-M, collectively referred to herein as edge nodes 102. The edge nodes 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is an adaptive resource allocation system 105 and one or more user devices 110. In some embodiments, the adaptive resource allocation system 105 can correspond to, or can be implemented on, a cloud server of an edge computing environment.

The edge nodes 102 may comprise, for example, servers and/or portions of one or more server systems or other devices. The user devices 110 may comprise, for example, mobile telephones, laptop computers, tablet computers, desktop computers, IoT devices (such as sensors and robots) or other types of computing devices. Such devices are examples of what are more generally referred to herein as “processing devices.” Some of these processing devices are also generally referred to herein as “computers.”

The edge nodes 102 in some embodiments comprise respective computers associated with one or more users and/or a particular company, organization, or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

In the FIG. 1 embodiment, it is assumed that each of the edge nodes 102 include respective data collectors 120-1, . . . 120-M (collectively referred to herein as data classifiers 120) and one or more respective services 122-1, . . . 122-M (collectively referred to herein as services 122). In some examples, at least a portion of the services 122 can be configured to process requests associated with the user devices 110, for example.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the edge nodes 102 and/or the adaptive resource allocation system 105 can have one or more associated databases 106 configured to store data, such as data collected by the data collectors 120. In some examples, the data can be collected using a unified usage data framework. The data can relate to, for example, utilization metrics and/or performance metrics of the services 122, as described in more detail herein.

An example database 106, such as depicted in the present embodiment, can be implemented using one or more storage systems associated with the adaptive resource allocation system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the adaptive resource allocation system 105 are one or more input-output devices, which illustratively comprise keyboards, displays or other types of input-output devices in any combination. Such input-output devices can be used, for example, to support one or more user interfaces to the adaptive resource allocation system 105, as well as to support communication between adaptive resource allocation system 105 and other related systems and devices not explicitly shown.

Additionally, the adaptive resource allocation system 105 in the FIG. 1 embodiment is assumed to be implemented using at least one processing device. Each such processing device generally comprises at least one processor and an associated memory and implements one or more functional modules for controlling certain features of the adaptive resource allocation system 105. More particularly, the adaptive resource allocation system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

A network interface may allow the adaptive resource allocation system 105 to communicate over the network 104 with the edge nodes 102, and illustratively comprises one or more conventional transceivers.

The adaptive resource allocation system 105 further comprises a data collection engine 112, a first machine learning model 114, and a second machine learning model 116.

Generally, the data collection engine 112 obtains data from the data collectors 120. For example, the data can comprise usage data related to services 122, which in some embodiments can be stored and/or processed by the first machine learning model 114 and the second machine learning model 116, for example.

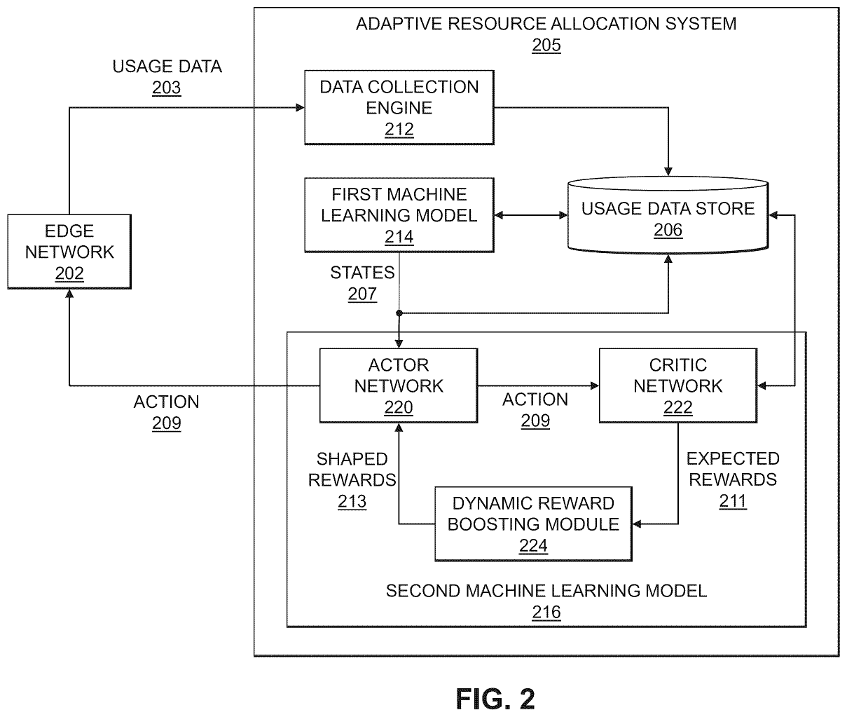

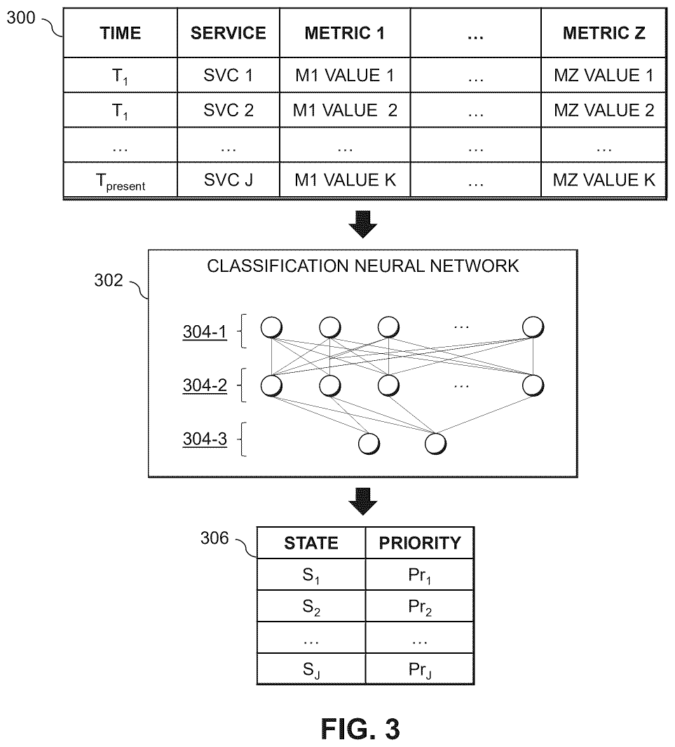

The first machine learning model 114, in some embodiments, is trained to predict respective states of the one or more services 122 based on the collected usage data. The state predicted for a given one of the services 122 can include information indicating (i) whether a resource configuration can be improved for the given service and/or (ii) a priority of the given service. As a non-limiting example, the first machine learning model 114 can comprise a classification neural network such as a Feed-Forward Neural Network (FFNN). These and other features of the first machine learning model 114 are described in more detail in conjunction with FIGS. 2 and 3, for example.

According to some embodiments, the second machine learning model 116 is trained to continuously improve (e.g., optimize) resource allocations for the services 122 based at least in part on the results of the first machine learning model 114. The second machine learning model 116 may comprise a deep reinforcement learning network, which in some embodiments comprises an actor-critic architecture, as explained in more detail in conjunction with FIGS. 2, 4 and 5, for example.

The FIG. 1 example shows the adaptive resource allocation system 105 separately from the edge nodes 102; however, this is not intended to be limiting and in other embodiments at least a portion of the adaptive resource allocation system 105 can be implemented on at least one of the edge nodes 102, or vice versa, for example.

It is to be appreciated that this particular arrangement of elements 112, 114 and 116 illustrated in the adaptive resource allocation system 105 and elements 120 and 122 illustrated in the edge nodes 102 of the FIG. 1 embodiment are presented by way of example only, and alternative arrangements can be used in other embodiments. For example, the functionalities associated with the elements 112, 114, and 116 and/or the functionalities associated with elements 120 and 122 in other embodiments can be combined into a single element or separated across a larger number of elements. As another example, multiple distinct processors can be used to implement different ones of the elements 112, 114, and 116 and/or different ones of the elements 120 and 122, or portions thereof.

At least portions of elements 112, 114 and 116 and/or at least portions of elements 120 and 122 may be implemented at least in part in the form of software that is stored in memory and executed by a processor.

It is to be understood that the particular set of elements shown in FIG. 1 for the adaptive resource allocation system 105 involving edge nodes 102 of computer network 100 is presented by way of illustrative example only, and in other embodiments additional or alternative elements may be used. Thus, another embodiment includes additional or alternative systems, devices, and other network entities, as well as different arrangements of modules and other components. For example, in at least one embodiment, one or more of the adaptive resource allocation system 105 and the one or more databases 106 can be on and/or part of the same processing platform.

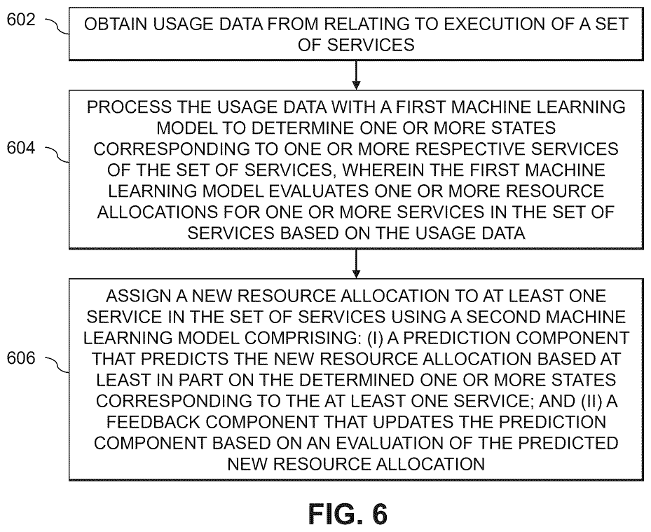

An exemplary process utilizing elements 112, 114, and 116 of an example adaptive resource allocation system 105 in computer network 100 will be described in more detail with reference to, for example, the flow diagram of FIG. 6.

FIG. 2 illustrates an adaptive resource allocation architecture in an exemplary embodiment. The adaptive resource allocation architecture shown in FIG. 2 includes an edge network 202 (e.g., corresponding to edge nodes 102 and user devices 110), and an adaptive resource allocation system 205 (e.g., corresponding to adaptive resource allocation system 105). In this example, the adaptive resource allocation system 205 comprises a data collection engine 212 that collects usage data 203 from the edge network 202 and stores the usage data 203 in a usage data store 206. The adaptive resource allocation system 205 also comprises a first machine learning model 214 and a second machine learning model 216. The second machine learning model 216 comprises an actor network 220, a critic network 222, and a dynamic reward boosting module 224.

In some embodiments, the first machine learning model 214 is trained to predict whether the resource allocation of the edge network 202 can be improved. The first machine learning model 214 can process the usage data 203, corresponding to one or more time periods, in the usage data store 206 to determine whether the resources allocated to the edge network 202 can be improved. In some embodiments, the first machine learning model 214 can process the usage data 203 to predict respective states 207 for a plurality of services executing on one or more edge nodes in the edge network 202. For example, states 207 can comprise a parameter to indicate whether or not a resource allocation for a given service can be improved. For example, a first value can indicate that the resource allocation cannot be improved, and a second value can indicate that the resource allocation can be improved. In at least some embodiments, the first machine learning model 214 also determines respective priorities for the services. For example, the first machine learning model 214 can predict a priority bucket (or category) for each edge service, where each bucket corresponds to a policy for resource allocations having different priorities (none, low, medium, and high priorities, as non-limiting examples). The first machine learning model 214 can predict the priority for a given edge service based on one or more resource requirements and one or more performance thresholds (e.g., quality of service (QOS) thresholds).

In some embodiments, the actor network 220 obtains at least a portion of the states 207 output by the first machine learning model 214. For example, the actor network 220 can obtain the states 207 for services having resource allocations that can be improved as input. The states 207 for services having resource allocations that cannot be improved can be discarded or ignored by the actor network 220.

The actor network 220 can be trained to select at least one action 209 to perform based on the current status of the edge network 202, where the status corresponds to the states 207 and the usage data 203. For example, the action 209 can include determining and assigning new resource allocations for the services having resource allocations that can be improved. The new resource allocations can correspond to values and/or ranges of values for one or more computing resources (e.g., CPU resources and/or memory resources). The action 209 determined by the actor network 220 is also provided to the critic network 222 of the second machine learning model 216.

The critic network 222 evaluates the action 209 taken by the actor network 220 to produce expected rewards 211. For example, the critic network 222 can apply a loss function based on one or more performance metrics of the services that were assigned resource allocations by the actor network 220. The critic network 222 outputs the expected rewards 211 to the dynamic reward boosting module 224 to provide feedback to the actor network 220 in the form of shaped rewards 213. For example, the shaped rewards 213 can be computed using a dynamic reward boosting process with an advantage function. In some embodiments, the shaped rewards 213 are computed based on a static base reward and a dynamic boost reward determined using an advantage function and/or a static advantage function with a dynamic base reward, as explained in more detail herein.

The actor network 220 may be updated based on the shaped rewards 213 to improve the resource allocation predictions for the services in the edge network 202. In some embodiments, the actor network 220 is continuously improved over time based on the shaped rewards 213 until one or more criteria are satisfied (e.g., the resource allocations for all edge services are substantially optimized).

In some embodiments, the usage data 203 can correspond to one or more performance metrics and/or one or more utilization metrics determined for nodes and/or containers in the edge network 202. The usage data 203 can be streamed from the edge network 202 to the adaptive resource allocation system 205 for processing by the first machine learning model 214 and the second machine learning model 216, for example. Although some embodiments are described with reference to an actor-critic network, it is to be appreciated that other types of machine learning models can be used in other embodiments, such as a generative adversarial network (GAN) model.

FIG. 3 illustrates a classification machine learning model architecture in an illustrative embodiment. In this example, the classification machine learning model architecture includes a classification neural network 302 that includes an input layer 304-1, a hidden layer 304-2, and an output layer 304-3.

A set of usage data 300 (e.g., corresponding to usage data 203) is processed by the input layer 304-1 of the classification neural network 302. The usage data 300 includes a set of metrics (metrics 1 through Z) for a plurality of services (denoted SVC 1 through SVC J) collected during a time period from time T₀ to time Tₚᵣₑₛₑₙₜ. The metrics can include, for example, CPU resources allocated, CPU resources used, memory resources allocated, memory resources used, average response times, a number of HTTP requests, and/or other types of performance or utilization metrics. In some embodiments, the metrics are used as input features for predicting a current state and/or a priority bucket for each service in a given cluster of an edge network (e.g., edge network 202).

In some embodiments, the hidden layer 304-2 processes the features from the input layer 304-1 using weights and biases. For example, the hidden layer 304-2 can use a Rectified linear (ReLU) activation function to introduce non-linearity for enabling the classification neural network 302 model to learn complex patterns in the usage data 300. Activations for neurons (represented by the circles in the classification neural network 302 shown in FIG. 3) can be performed using ReLU activation with weights (denoted W1) and a bias term (denoted B1) as follows: weighted_sum=W1*Input+B1, and first_hidden_layer_activations=ReLU (weighted_sum).

The output layer 304-3, in some embodiments, comprises two neurons, which represent a binary classification output state and a priority classification, respectively. A first one of the neurons in the output layer 304-3 can correspond to a Sigmoid activation function for producing a probability value (e.g., between 0 and 1), which indicates a probability of whether a resource allocation can be improved (e.g., optimized). For example, assuming a set of weights (W2) and a set of bias terms (B2) for binary classification with Sigmoid, the output layer binary activation can be determined using the following equations:

Sigmoid(x)=1/(1+exp(−x)),

weighted_sum_binary=W2*first_hidden_layer_activations+B2,

output_layer_binary_activation=Sigmoid(weighted_sum_binary).

The output_layer_binary_activation value can represent an estimated probability for a given service in the edge network being in a particular state. In some examples, if the computed output value is less than a threshold value (e.g., 0.5), then the predicted state indicates that the resource allocation can be improved, and if the computed output value is greater than or equal to the threshold value, then the predicted state indicates that the resource allocation cannot be improved.

The second neuron of the output layer 304-3, in some embodiments, can use a SoftMax activation function to convert each of a plurality of priority categories into a probability distribution over all categories. The second output neuron can ensure, for example, that the sum of the probabilities for all categories is equal to one. For example, assuming a set of weights (denoted W3) and a set of bias terms (denoted B3) for the category with Softmax, the output layer binary activation can be determined using the following equations:

Softmax(xⱼ)=exp(xⱼ)/sum(exp(xᵢ) for all i), where i corresponds to the plurality of priority categories;

weighted_sum_caterogy=W3*first_hidden_layer_activations+B3;

output_layer_category_activation=Softmax(weighted_sum_category).

Consider an example where [0.1, 0.3, 0.4, 0.2] represents probabilities that a given input belongs to a respective one of the categories (e.g., none, low, medium, or high). Then, if output_layer_category_activation for the given input is 0.4, then it is predicted as belonging to the medium category.

The output of the classification neural network 302 is shown in the table 306, which includes states (denoted S₁, . . . S_{J}) and priorities (denoted Pr₁, . . . Pr_{J}) for the services.

As noted above, the second machine learning model 116 can include an actor network and a critic network (as shown in FIG. 2, for example). For example, the second machine learning model 116 can comprise a deep reinforcement learning framework based on an advantage actor-critic (A2C) algorithm. Generally, the actor network includes functionality for selecting actions in an environment, and a policy function maps states (also referred to as observations) to the actions. In some embodiments, the actions map to prediction and assignment of dynamic resource values in an edge cluster, where the edge cluster corresponds to the environment.

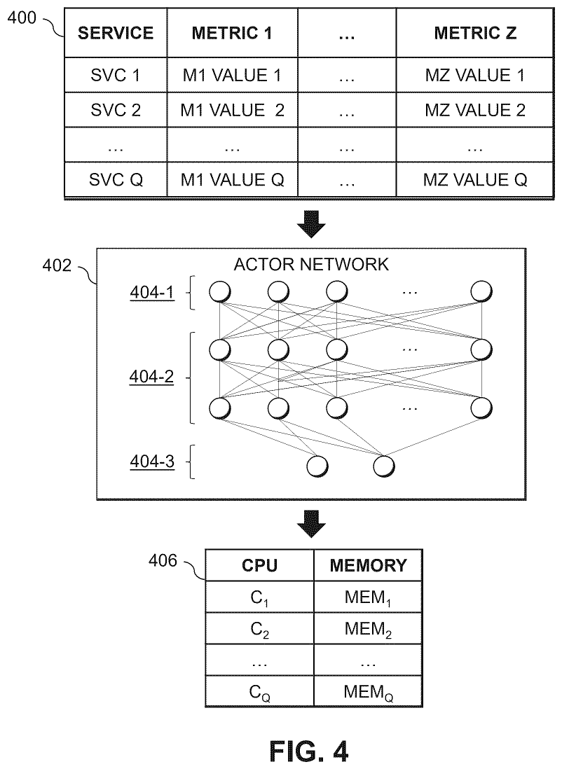

FIG. 4 illustrates a neural network architecture for an actor network 402 in accordance with an illustrative embodiment. The actor network 402 includes an input layer 404-1, a set of hidden layers 404-2, and an output layer 404-3.

The input layer 404-1 obtains input data 400. For example, the input data 400 can include usage data corresponding to the services (denoted SVC 1 through Q) having resource allocations that can be improved, as determined by the first machine learning model 114. As a non-limiting example, the usage data 300 can be filtered to remove the data associated with the services that cannot be improved. Accordingly, the features in the input data 400 can include similar metrics as the usage data 300 (e.g., for the time period from time T₀ to time Tₚᵣₑₛₑₙₜ). The input data 400 can optionally include the states and priority buckets output by the first machine learning model 114. The input features (referred to as X) are provided to the first one of the hidden layers 404-2.

The first hidden layer, in some examples, can include a set of neurons that process the input data 400 using weights and biases by applying a ReLU activation function. Accordingly, each of the neurons in the first hidden layer can be associated with a weight (denoted W1) and a bias term (b1). For each neuron in the first hidden layer, the weighted sum (denoted Z1) of the input features, combined with their corresponding weights, is calculated as Z1=W1*X+b1. The output of the weighted sum (Z1) is processed using the ReLU activation function, which can replace negative values with zero values. This can be represented as A1=ReLU(Z1), where A1 represents the output of the first hidden layer.

The output of the first hidden layer is provided as input to a second one of the hidden layers 404-2. Similar to the first hidden layer, each neuron in the second layer includes a weight (denoted W2) and a bias term (denoted b2). The weighted sum (denoted Z2) of the inputs from the first hidden layer and their corresponding weights are calculated as: Z2=W2*A1+b2. W2 is processed by the ReLU activation function as follows: A2=ReLU(Z2), where A2 represents the output of the second hidden layer.

The output layer 404-3 generates the allocation configuration 406, which includes predicted CPU resources (denoted C₁, . . . C_{Q}) and memory resources (denoted MEM₁, . . . MEM_{Q}) in this example. Each of the neurons in the output layer 404-3 also has a corresponding set of weights (denoted W3, W4) and bias terms (denoted b3, b4), which correspond to the hidden layer outputs A1 and A2.

As an example, a first neuron of the output layer 404-3 can correspond to the predicted CPU resources. The first neuron can apply a SoftPlus activation function to a weighted sum (Z3). As an example, the first neuron can be expressed as follows:

Z3=W3*A1+b3,

Cₓ=SoftPlus(Z3).

A second neuron of the output layer can be used to predict the memory resource allocation, using a similar approach as the first neuron. For example, the second neuron can be expressed as follows:

Z4=W4*A2+b4, where Z4 is a weighted sum,

Mx=SoftPlus(Z4).

Referring again to FIG. 2, the actor network 220 in some embodiments can be updated using the shaped rewards 213 to improve learning rates of the actor policies, thereby resulting in faster learning for the resource allocation process.

The critic network 222 serves as an evaluator, analyzing the actions (e.g., the resource predictions determined by the actor network 220) and determining an improved value (e.g., an optimal value) for the resource allocations. The shaped rewards determined with the critic network 222 and the dynamic reward boosting module 224 can provide feedback for guiding the decision-making process of the actor network 220.

As an example, the critic network 222 can obtain inputs corresponding to the current state of the environment and the allocation decisions (e.g., resource predictions) generated by the actor network 220. The critic network 222 can then estimate a current value (V) of the actor network 220 based on the current states and the current policy. The estimated current value of the actor network 220, in some embodiments, is represented by a state-value function, denoted V(s). The inputs of the critic network 222 can include the current states of the services and the actions (e.g., predicted optimal resources) determined by the actor network 220. The expected rewards 211 output by the critic network 222 can comprise an estimated cumulative reward, corresponding to V(s), for each of the services.

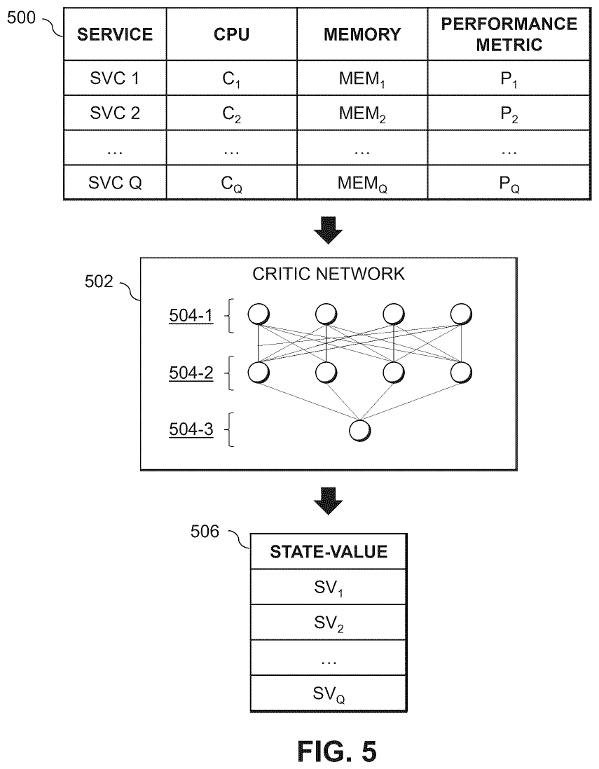

FIG. 5 illustrates a neural network architecture for a critic network 502 in an illustrative embodiment. The critic network 502 includes an input layer 504-1, a hidden layer 504-2, and an output layer 504-3. The input layer 504-1 obtains input data 500 comprising the resource configurations predicted and assigned by the actor network (e.g., actor network 402), and at least one performance metric (denoted P₁, P₂, . . . P_{Q}). The hidden layer 504-2 can process the input features using weights and biases and applying a ReLU activation function. The output layer 504-3 can be used to predict the estimated cumulative rewards for the services.

In some embodiments, the state-value function, V(s), can be expressed as follows: V(s)=E[Σ(γ\hat{ }t*Rₜ)|s, π], where V(s) is the state-value function for state, s, E is the expected value, Σ represents the sum over time steps, γ is a discount factor for discounting future rewards in the sum, Rₜ is a reward obtained at time step t, s is the current state, and π is the actor network's policy, specifying the probability of taking actions in different states. V(s) provides an estimate of the expected cumulative reward that an agent can achieve when starting from a specific state s and in its current policy π.

In some embodiments, the critic network 502 can be trained using a loss function and a backpropagation process. For example, the loss function can be used for calculating how effective the state values are being estimated. One example of a loss function for the critic network 502 is a Mean Squared Error (MSE) loss function, which reduces differences between the predicted resource estimate values (V(s)) and the actual allocated resource values from the usage data.

The loss for training the critic network 502 can be computed as: loss_critic=MSE(V(s), V_{Target}), where V_{Target} is a target resource value, calculated as the discounted sum of future rewards from the current state, and V(s) is a predicted resource estimate value generated by the critic network 502. The critic network 502 updates its parameters using the backpropagation process to reduce the MSE loss. For example, the critic network 502 can adjust its internal parameters to improve an accuracy of the resource estimates.

In some embodiments, a reward boosting process (e.g., performed by the dynamic reward booting module 224) is performed based on the output of the critic network (e.g., the critic network 222). For example, the dynamic reward boosting process can determine base rewards, which represent immediate feedback the actor network 220 receives when it attempts to improve resources for each state. In some embodiments, the base rewards can be positive, negative, or zero and can provide information indicating an impact (or advantage) of the resource estimates.

For example, an advantage function, A(s, a), can be used to calculate how much better or worse taking a specific action “a” in a particular state “s” is compared to the expected action in the same state. Accordingly, the advantage function can help the actor network (e.g., actor network 220) evaluate the performance of particular resource allocations (e.g., whether the performance is better than the expected resource allocation under its policy in each state).

In some embodiments, the advantage function can be defined as: A(s, a)=Q(s, a)−V(s), where A(s, a) evaluates taking action “a” in the current state “s”, Q(s, a) is the state-action value, and V(s) corresponds to the output of the critic network.

According to some embodiments, the dynamic reward boosting process can incorporate the insights of the critic network into the reward structure. By way of example, the dynamic reward boosting process can be used to derive shaped rewards (s, a) based on the following two functions:
γ(s, a)=static base rewards with dynamic advantage function,
β(s, a)=dynamic base rewards with static advantage function.

For the static base rewards with dynamic advantage function, the base rewards are considered static during training and the advantage function is dynamic, (e.g., it is updated over time as the actor network learns). The actor network can explore the edge network using the dynamic advantage function with a learning rate hyperparameter (α), and learns from different resource allocation strategies. The dynamic advantage function enables the actor network to understand the advantage of selecting one resource allocation relative to another resource allocation for a particular state.

For the case of dynamic base rewards with a static advantage function, dynamic base rewards are derived using a learning rate hyperparameter (α) that can change over time based on the actor network's resource allocation. The base rewards can be updated during the training period, for example. The static advantage function remains constant during training and does not change as the agent performs resource predictions during training. This can help the agent fine-tune the dynamic base rewards to select improved resource allocations for a particular state.

The shaped reward is derived by comparing γ and β for a specific state, s, and action, a. The shaped reward can be expressed as, for example: Shaped Reward (s, a)=max (γ(s, a), β(s, a)).

According to one or more embodiments, the policy of the actor network can be updated based on the shaped rewards. For example, the actor network can be retrained using the shaped rewards (s, a). After the actor network is retrained, the actor network attempts to increase the expected return based on the shaped rewards. This can encourage the actor network to select actions that lead to higher shaped rewards rather than immediate rewards.

FIG. 6 illustrates a flow diagram of a process for adaptive resource allocation in an illustrative embodiment. It is to be understood that this particular process is only an example, and additional or alternative processes can be carried out in other embodiments.

In this embodiment, the process includes steps 602 through 606. These steps are assumed to be performed by the adaptive resource allocation system 105 utilizing its elements 112, 114 and 116.

Step 602 includes obtaining usage data relating to execution of a set of services.

Step 604 includes processing the usage data with a first machine learning model to determine one or more states corresponding to one or more respective services of the set of services, wherein the first machine learning model evaluates one or more resource allocations for one or more services in the set of services based on the usage data.

Step 606 includes assigning a new resource allocation to at least one service in the set of services using a second machine learning model comprising: (i) a prediction component that predicts the new resource allocation based at least in part on the determined one or more states corresponding to the at least one service; and (ii) a feedback component that updates the prediction component based on an evaluation of the predicted new resource allocation.

The feedback component may evaluate the predicted new resource allocation using a loss function and provide feedback for updating the prediction component according to a reward structure.

The reward structure may be based on a dynamic reward boosting process comprising a dynamic advantage function using static baseline rewards and/or a static advantage function using dynamic baseline rewards.

The first machine learning model may include a feed-forward neural network.

The prediction component may include an actor network and the feedback component comprises a critic network.

The one or more states, determined for a corresponding service, may include information indicating whether the resource allocation can be improved for the corresponding service, and a priority level specified for the corresponding service.

The usage data may be collected from one or more edge nodes that implement the set of services. For example, the set of services can be implemented using one or more containers.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments can provide significant advantages relative to conventional approaches. For example, at least some embodiments described herein provide a deep reinforcement learning framework that can improve resource allocations for edge services. Some embodiments can improve resource allocations through vertical scaling. Additionally, one or more embodiments can dynamically allocate resources based on substantially real-time demand, thereby improving utilization of resources, including computational power, memory, and/or network bandwidth resources in the edge network. Some embodiments can adjust resource allocation to reduce latency for critical edge applications and services, which can be particularly important for real-time or near real-time applications (e.g., industrial automations, where even small delays can cause severe consequences. Also, some embodiments can prioritize resource allocations to ensure that applications satisfy predefined quality of service (QOS) thresholds.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionalities within the system 100. For example, containers can be used to implement respective processing devices providing compute and/or storage services of a cloud-based system. Again, containers may be used in combination with other virtualization infrastructure such as virtual machines implemented using a hypervisor.

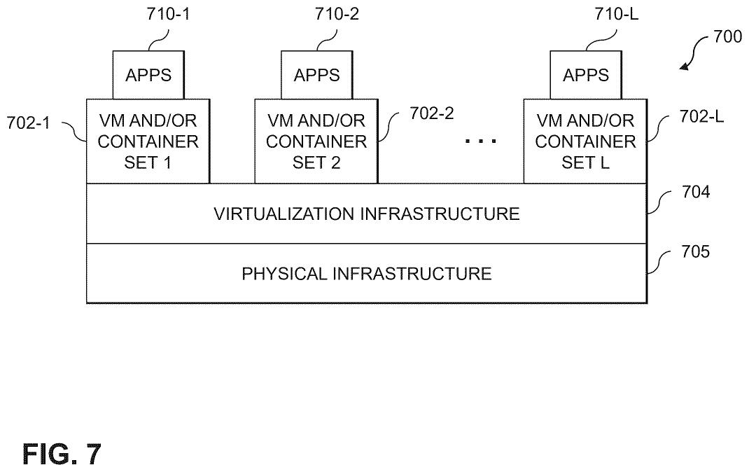

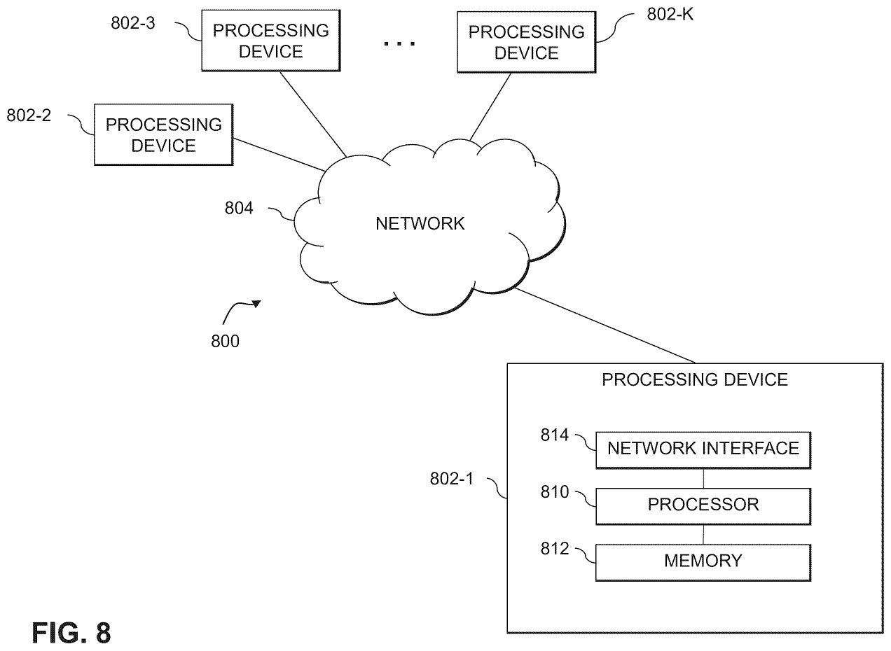

Illustrative embodiments of processing platforms will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, a microcontroller, an ASIC, an FPGA or other type of processing circuitry, as well as portions or combinations of such circuitry elements.

The memory 812 comprises RAM, ROM or other types of memory, in any combination.

The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method, comprising:
obtaining usage data relating to execution of a set of services;
processing the usage data with a first machine learning model to determine one or more states corresponding to one or more respective services of the set of services, wherein the first machine learning model evaluates one or more resource allocations for one or more services in the set of services based on the usage data; and
assigning a new resource allocation to at least one service in the set of services using a second machine learning model comprising: (i) a prediction component that predicts the new resource allocation based at least in part on the determined one or more states corresponding to the at least one service; and (ii) a feedback component that updates the prediction component based on an evaluation of the predicted new resource allocation;
wherein the method is performed by at least one processing device comprising a processor coupled to a memory.

2. The computer-implemented method of claim 1, wherein the feedback component:
evaluates the predicted new resource allocation using a loss function; and
provides feedback for updating the prediction component according to a reward structure.

3. The computer-implemented method of claim 2, wherein the reward structure is based on a dynamic reward boosting process comprising at least one of:
a dynamic advantage function using static baseline rewards; and
a static advantage function using dynamic baseline rewards.

4. The computer-implemented method of claim 1, wherein the first machine learning model comprises a feed-forward neural network.

5. The computer-implemented method of claim 1, wherein the prediction component comprises an actor network and the feedback component comprises a critic network.

6. The computer-implemented method of claim 1, wherein the one or more states, determined for a corresponding service, comprises information indicating:
whether the resource allocation can be improved for the corresponding service; and
a priority level specified for the corresponding service.

7. The computer-implemented method of claim 1, wherein the usage data is collected from one or more edge nodes that implement the set of services.

8. A non-transitory processor-readable storage medium having stored therein program code of one or more software programs, wherein the program code when executed by at least one processing device causes the at least one processing device:
to obtain usage data relating to execution of a set of services;
to process the usage data with a first machine learning model to determine one or more states corresponding to one or more respective services of the set of services, wherein the first machine learning model evaluates one or more resource allocations for one or more services in the set of services based on the usage data; and
to assign a new resource allocation to at least one service in the set of services using a second machine learning model comprising: (i) a prediction component that predicts the new resource allocation based at least in part on the determined one or more states corresponding to the at least one service; and (ii) a feedback component that updates the prediction component based on an evaluation of the predicted new resource allocation.

9. The non-transitory processor-readable storage medium of claim 8, wherein the feedback component:
evaluates the predicted new resource allocation using a loss function; and
provides feedback for updating the prediction component according to a reward structure.

10. The non-transitory processor-readable storage medium of claim 9, wherein the reward structure is based on a dynamic reward boosting process comprising at least one of:
a dynamic advantage function using static baseline rewards; and
a static advantage function using dynamic baseline rewards.

11. The non-transitory processor-readable storage medium of claim 8, wherein the first machine learning model comprises a feed-forward neural network.

12. The non-transitory processor-readable storage medium of claim 8, wherein the prediction component comprises an actor network and the feedback component comprises a critic network.

13. The non-transitory processor-readable storage medium of claim 8, wherein the one or more states, determined for a corresponding service, comprises information indicating:
whether the resource allocation can be improved for the corresponding service; and
a priority level specified for the corresponding service.

14. The non-transitory processor-readable storage medium of claim 8, wherein the usage data is collected from one or more edge nodes that implement the set of services.

15. An apparatus comprising:
at least one processing device comprising a processor coupled to a memory;
the at least one processing device being configured:
to obtain usage data relating to execution of a set of services;
to process the usage data with a first machine learning model to determine one or more states corresponding to one or more respective services of the set of services, wherein the first machine learning model evaluates one or more resource allocations for one or more services in the set of services based on the usage data; and
to assign a new resource allocation to at least one service in the set of services using a second machine learning model comprising: (i) a prediction component that predicts the new resource allocation based at least in part on the determined one or more states corresponding to the at least one service; and (ii) a feedback component that updates the prediction component based on an evaluation of the predicted new resource allocation.

16. The apparatus of claim 15, wherein the feedback component:
evaluates the predicted new resource allocation using a loss function; and
provides feedback for updating the prediction component according to a reward structure.

17. The apparatus of claim 16, wherein the reward structure is based on a dynamic reward boosting process comprising at least one of:
a dynamic advantage function using static baseline rewards; and
a static advantage function using dynamic baseline rewards.

18. The apparatus of claim 15, wherein the first machine learning model comprises a feed-forward neural network.

19. The apparatus of claim 15, wherein the prediction component comprises an actor network and the feedback component comprises a critic network.

20. The apparatus of claim 15, wherein the usage data is collected from one or more edge nodes that implement the set of services.
